(19) United States
(12) Patent Application Publication
(10) Pub. No.: US 2024/0399525 A1
(43) Pub. Date: Dec. 5, 2024

(54) SYSTEM AND A METHOD FOR DETERMINING CONTACT BETWEEN A CUTTING TOOL AND AN ELECTRICALLY CONDUCTIVE WORKPIECE

(71) Applicant: SECO TOOLS AB, Fagersta (SE)

(72) Inventor: Amir KARIM, Fagersta (SE)

(21) Appl. No.: 18/696,251

(22) PCT Filed: Sep. 22, 2022
(86) PCT No.: PCT/EP2022/076303

§ 371 Date: Mar. 27, 2024

(30) Foreign Application Priority Data
Sep. 29, 2021 (EP) 21199706.9

(51) Int. Cl. B23Q 17/22

(52) U.S. Cl. CPC B23Q 17/2241

(57) ABSTRACT

A system and method for determining contact between a cutting tool and an electrically conductive workpiece is provided. The cutting tool includes a toolholder and a plurality of cutting inserts mounted in the toolholder. Each of the cutting inserts has an electrically conductive surface layer and are electrically insulated from the toolholder. Each of the cutting inserts are connected in parallel to a first pole of an electric power source via a respective first connection unit and a second connection unit is connected to a second pole of the electric power source and electrically connected to the electrically conductive workpiece. A measuring unit is operatively connected to an analysis unit and is configured to measure an electrical voltage over each of the first connection units. The analysis unit is configured to determine a contact between the cutting tool and an electrically conductive workpiece based on the measured electrical voltages.

### TECHNICAL FIELD

The present invention relates to a system and a method for determining contact between a cutting tool an electrically conductive workpiece.

### BACKGROUND

In a cutting process, a cutting tool, having a cutting edge, is arranged to be brought in contact with a workpiece in order to bring the workpiece into a desired shape and size by removal of chips from the workpiece. Before starting the cutting process, the position of the cutting edge should be determined in order to create a cutting program that results in a high quality of the workpiece. This determination is usually performed by manual inspection by the operator determining when the cutting tool comes into contact with the workpiece, which is a time consuming process. During the cutting process it is often necessary to change the cutting tool or a part of the cutting tool since it becomes worn out. The position of the new cutting edge should then be determined again before the cutting process is re-started. When performing multiple, complex cutting processes where a lot of tool changes are needed, a lot of time is spent on determining cutting edge positions between cutting, thereby lowering the productivity of the cutting process.

Attempts to solve this problem have been made by incorporating measurement equipment on a machine level for determining, e.g. power changes or spindle vibrations which will change when the tool starts cutting the workpiece. Such a solution is disclosed in US 2020/0215710 A1.

A problem with these solutions is that they are not very accurate, and the risk of incorrect determinations of the cutting edge position is high, resulting in high risk for a reduced quality of the machined workpiece.

### SUMMARY OF THE INVENTION

It is an object of the present invention to overcome, or at least partially overcome, said problem by introducing a system and a method for determining contact between a cutting tool and an electrically conductive workpiece.

The object of the present invention is achieved by means of a system for determining contact between a cutting tool and an electrically conductive workpiece, the system comprises a cutting tool comprising a toolholder and n cutting inserts mounted in the toolholder, wherein n is an integer ≥2, wherein each of the n cutting inserts comprises an electrically conductive surface layer, wherein the cutting tool is configured to bring the n cutting inserts in and out of contact with an electrically conductive workpiece, characterized in that each of the n cutting inserts are electrically insulated from the toolholder; and in that the system further comprises an electrical circuit, wherein the electrical circuit comprises:
an electric power source arranged to generate an electrical voltage, and
n first connection units, which each comprises a first end, a second end, and, between the first end and the second end, a resistor having an electrical resistance, wherein each of the n first connection units are electrically connected to a respective cutting insert at the first end and to a first pole of the electric power source at the second end, wherein each of the n first connection units are electrically connected to the first pole in parallel with all the other n-1 first connection units, and
a second connection unit operatively connected to a second pole of the electric power source at a first end and comprising a contact adapted to be electrically connected to an electrically conductive workpiece at a second end; wherein
   the system further comprises a measuring unit and an analysis unit, wherein the measuring unit is configured to measure an electrical voltage over each of the first connection units, wherein the measuring unit is operatively connected to the analysis unit, wherein the analysis unit is configured to determine a contact between the cutting tool and an electrically conductive workpiece material based on the measured electrical voltages.

When a cutting insert mounted in the toolholder comes in contact with an electrically conductive workpiece, the electric power source, the first connection unit, the cutting insert, the electrically conductive workpiece and the second connection unit forms a closed electrical circuit, which results in an electrical current flowing through the circuit. When the electrical current flows through the first connection unit, an electrical voltage is measurable over the first connection unit, according to Ohm's law: U=R·I, where U is the electrical voltage, R is the electrical resistance, and I is the electrical current.

However, if a cutting insert is not in contact with an electrically conductive workpiece, no closed circuit is formed and no electrical current flows through the circuit. Accordingly, no electrical voltage is measurable over the first connection unit.

Accordingly, if a measured electrical voltage over any of the first connection units has a non-zero value, this indicates that the corresponding cutting insert is in contact with the electrically conductive workpiece, and the cutting tool is thus in contact with the workpiece.

The electrical insulation between the n cutting inserts and the toolholder prevents the current from flowing from one cutting insert to another cutting insert via the toolholder.

Since the system is configured to measure the electrical voltage over each of the first connection units, and since the cutting inserts are electrically insulated from the toolholder, it is possible for the analysis unit to determine a contact between individual inserts in the toolholder and an electrically conductive workpiece, which results in a very accurate determining of the position of different cutting edges in the cutting tool.

The cutting tool is any type of cutting tool, e.g. a milling cutter, a drilling tool, a boring tool or a turning tool. The cutting tool is preferably a metal cutting tool.

The surface layer of the cutting insert is defined as the outermost material layer of the cutting insert. The surface layer can be an electrically conductive coating on the cutting insert, comprising e.g. titanium-carbon-nitride (TiCN), titanium-nitride (TiN), chromium (Cr), titanium-aluminum-nitride (TiAIN), niobium-nitride (NbN) or titanium-silicon-nitride (TiSiN). In case of an uncoated cutting insert, the surface layer comprises the same material as the core of the cutting insert, e.g. cemented carbide.

The electric power source is preferably a battery.

The second connection unit is operatively connected to the second pole of the electric power source either directly via e.g. an electric cable or indirectly via e.g. electrically conductive machine parts.

The measuring unit preferably comprises n measurement devices configured for measuring electrical voltage, either directly by e.g. voltmeters or indirectly by measuring the electrical current in the first connection units by e.g. amperemeters.

Accordingly, the electrical voltage over each of the n first connection units can be measured either directly over the first connection units or indirectly by measuring the electrical current in each of the first connection units.

According to an embodiment, each of the n first connection units comprises only one resistor. The resistor preferably has a much higher electrical resistance than the rest of the components in the first connection unit, which are electrical conductors. The resistor preferably has an electrical resistance that is at least 1000 times higher than the electrical resistance of the other components in the first connection unit.

According to an embodiment, the electrical voltage over each of the n first connection units are preferably measured by measuring the electrical voltage over the resistor in the respective first connection unit.

Since the electrical resistance of the resistor is much higher than for the rest of the components in the first connection unit, the electrical voltage over the resistor is representative of the electrical voltage over the first connection unit.

According to an embodiment, each of the n first connection units comprises a plurality of resistors connected in series. In this case, the electrical voltage over each of the n first connection units are preferably measured by measuring the electrical voltage over one of the resistors in the respective first connection unit. The electrical voltage can also be measured over a plurality of the resistors in the respective first connection unit.

In order to determine if an electrical current flow through the first connection unit, and the corresponding cutting insert is in contact with an electrically conductive workpiece, it is enough to measure the electrical voltage over one of the resistors in the first connection unit in this embodiment.

The analysis unit is a unit is configured to interpret and analyze the measured electrical voltages. The analysis unit is e.g. a computer.

According to an embodiment, the system further comprises an electrically conductive workpiece, wherein the electrically conductive workpiece is electrically connected to the second pole of the electric power source via the contact.

The electrically conductive workpiece is e.g. a metallic workpiece.

According to an embodiment, the toolholder, the electrically conductive workpiece material, and one of the first or second poles of the electric power source have the same electrical potential.

By having the toolholder, the electrically conductive workpiece material, and one of the first or second poles of the electric power source arranged at the same electrical potential, the measurement of the electrical voltages over the first connection units are facilitated, due to the reduced amount of calibration needed to be performed by the analysis unit.

According to an embodiment, the toolholder, the electrically conductive workpiece material, and one of the first or second poles of the electric power source are electrically grounded.

By having the toolholder, the electrically conductive workpiece material, and one of the first or second poles of the electric power source electrically grounded, the measurement of the electrical voltages over the first connection units are facilitated, due to the reduced amount of calibration needed to be performed by the analysis unit.

According to an embodiment, the toolholder comprises n insert pockets, wherein each of the n cutting inserts are mounted in one respective insert pocket, wherein each of the n insert pockets comprises an electrically insulating material layer between the toolholder and the cutting insert mounted in the insert pocket.

By providing an insulating material layer between the toolholder and the cutting insert, the cutting insert will be electrically insulated from the toolholder. This electrical insulation prevents the current from flowing from one cutting insert to another cutting insert via the toolholder. Due to this, it is possible to determine a contact between individual cutting inserts and an electrically conductive workpiece.

According to an embodiment, each of the n first connection units comprises an electrical contact pad at the first end, which is arranged in electrical contact with the electrically conductive surface layer of the respective cutting insert.

By providing the first end of the n first connection units with an electrical contact pad, the connection of the cutting inserts to the first pole of the electric power source is facilitated.

According to an embodiment, each of the electric contact pads are arranged in one respective insert pocket between the electrically insulating material layer and the cutting insert mounted in the insert pocket.

By having each of the electric contact pads are arranged in one respective insert pocket between the electrically insulating material layer and the cutting insert mounted in the insert pocket, the connection of the cutting inserts to the first pole of the electric power source is facilitated. Due to this feature, the cutting inserts can be mounted in the insert pockets by use of conventional fastening devices and at the same time being connected to the first pole of the electric power source, i.e. no further steps of connecting the cutting inserts are needed.

According to an embodiment, all the first connection units have the same electrical resistance.

By letting all the first connection units have the same electrical resistance, it is possible to detect which individual cutting inserts that are in contact with an electrically conductive workpiece material in the situation where a plurality of cutting inserts is in contact with the electrically conductive workpiece at the same time.

According to an embodiment, each of the first connection units have an electrical resistance of between 50 kΩ and 500 kΩ.

According to an embodiment, the measuring unit is operatively connected to the analysis unit via a wireless connection. The wireless connection being e.g. a Wireless Local Area Network, WLAN, Bluetooth™, ZigBee, Ultra-Wideband, Near Field Communication, NFC, Radio Frequency Identification, RFID, or similar network.

According to an embodiment, the electric power source and the measuring unit are arranged in the toolholder.

By having the electric power source and the measuring unit arranged in the toolholder, the system becomes compact and can be implemented in cutting operations where there is a limited amount of space.

According to an embodiment, the cutting tool is a rotating tool, e.g. a milling cutter, a drilling tool or a boring tool.

According to an embodiment, the toolholder is mounted, directly or indirectly in a machine part, and wherein the second connection unit is, at least partly, arranged within the machine part. The machine part is e.g. a machine spindle.

By having the second connection unit, at least partly, arranged within the machine part, the connection of the electrically conductive workpiece to the second pole of the electric power source is facilitated, since no external electrical connection is needed in the toolholder.

According to an embodiment, the measuring unit comprises an internal memory, wherein the internal memory is configured to store the measured electrical voltages, and wherein the measuring unit is configured to transmit the measured electrical voltages stored in the internal memory to the analysis unit.

By having an internal memory arranged in the measuring unit it is possible to transmit the measured electrical voltages to the analysis unit at a later stage if the connection between the measuring unit and the analysis unit is temporarily lost. In this way, contacts between the cutting tool and an electrically conductive workpiece can still be determined for the purpose of analyzing the usage of the cutting tool.

According to an embodiment, the analysis unit is configured to determine a contact between each of the n cutting inserts and an electrically conductive workpiece based on the measured electrical voltages.

By having the analysis unit configured to determine a contact between each of the n cutting inserts and an electrically conductive workpiece based on the measured electrical voltages, a very accurate determining of the position of all cutting edges in the cutting tool can be made and thereby reducing the risk of incorrect calibrations and thereby reducing the risk of reduced quality of the machined workpiece.

According to an embodiment, the system further comprises a time measurement device, which is operatively connected to the analysis unit, and wherein the analysis unit is adapted to determine the time of contact between any of the n cutting inserts and an electrically conductive workpiece.

According to an embodiment, the analysis unit is configured to determine the time of contact between each of the n cutting inserts and an electrically conductive workpiece.

According to an embodiment, the analysis unit is configured to compare the determined time of contact with a minimum threshold value and to discard the determined contact if the determined time of contact is shorter than the minimum threshold value.

By discarding determined contacts where the time of contact is shorter than the minimum threshold value, the amount of false determination is reduced. There might be, for example, a situation where a flying chip from the cutting process will, for a very short time, come in contact with a non-cutting cutting insert and the electrically conductive workpiece, thereby closing the electric circuit between the non-cutting insert and the electrically workpiece, which will then be determined as a contact. If the determined contact is discarded if the time of contact is shorter than a minimum threshold value this problem will be reduced. The minimum threshold value depends on the cutting process, e.g. which cutting feed rate or which rotational cutting speed is used.

According to an embodiment, the analysis unit is configured to determine a plurality of subsequent contacts between each of the n cutting inserts and an electrically conductive workpiece, and to determine the accumulated time of contact between each of the n cutting inserts and an electrically conductive workpiece.

By determining the accumulated time of contact between each of the n cutting inserts and an electrically conductive workpiece it is possible to estimate the amount of wear of each of the n cutting inserts since the wear is a function of the time of cut.

According to an embodiment, the system further comprises a user interface, wherein the user interface is operatively connected to the analysis unit, wherein the analysis unit is configured to compare the determined accumulated time of contact with a maximum threshold value, wherein the analysis unit is configured to generate a warning signal if the determined accumulated time of contact is equal to or higher than the maximum threshold value, and wherein the system is configured to generate a warning based on the generated warning signal, wherein the warning is presented via the user interface.

The user interface can be e.g. a visual user interface in form of e.g. a display or an audial user interface in form of e.g. a speaker. The warning can be e.g. a visual warning or an audial warning.

By comparing the accumulated time of contact with a maximum threshold value, it is possible for the analysis unit to determine when it is time to change the cutting insert since the wear of the cutting insert is a function of the time of cut. By doing this comparison it is possible to optimize the usage of each of the n cutting insert by not changing the cutting inserts too soon, which would result in an ineffective usage of the cutting inserts, and not too late, which would affect the quality of the machined workpiece. By presenting the warning via the user interface, an operator of the cutting tool is informed that it is time to change one or more of the n cutting inserts. The maximum threshold value depends on which cutting operation that is performed, which cutting data parameters that are used, e.g. cutting feed rate and rotational cutting speed, which type of workpiece that is processed, and which type of cutting inserts that are used in the cutting operation.

According to an embodiment, the analysis unit is operatively connected to a database, and wherein the system is configured to store the accumulated time of contact between each of the n cutting inserts and an electrically conductive workpiece in the database. The stored accumulated time of contact is preferably cross-referenced with information regarding the cutting process, such as cutting data parameters, type of workpiece processed and cutting insert information, in the database.

By storing the determined accumulated time of contact in the database, it is possible to track the historical usage of each of the n cutting inserts mounted in the toolholder.

According to an embodiment, the analysis unit is configured to determine a relation between the total machining operational time and the determined accumulated time of contact of the cutting inserts.

By determining a relation between the total machining operational time and the determined accumulated time of contact of the cutting inserts, the efficiency of the cutting process can be evaluated.

According to an embodiment, each of the n cutting inserts are provided with a unique identification marking. The unique identification marker is a machine readable code comprising unique cutting insert identification data. The unique cutting insert identification data can be e.g. a unique identification number. The unique identification marker can be e.g. a Quick Response code, a High Capacity Colored Two Dimensional Code, a European Article Number code, a DataMatrix code, an Radio Frequency Identification (RFID) code or a MaxiCode.

This unique cutting insert identification data can be linked to unique cutting insert information in a tool database provided by the tool manufacturer. By reading the unique cutting insert identification data, the unique cutting insert information can be accessed via e.g. a smartphone app with access to the tool database. The unique cutting insert information preferably comprises recommended time of usage of the insert for a specific cutting operation. The unique cutting insert information preferably also comprises geometrical information of the unique cutting insert.

The object of the present invention is further achieved by means of a method for determining contact between a cutting tool and an electrically conductive workpiece, the method comprises the steps of:
providing a system as disclosed above;
providing an electrically conductive workpiece;
operatively connecting the electrically conductive workpiece to the second pole of the electric power source via the contact;
electrically charging the electrically conductive surface layer of the n cutting inserts, by activating the electric power source;
measuring an electrical voltage over each first connection unit;
transmitting the measured electrical voltages to the analysis unit; and
determining a contact between the cutting tool and the electrically conductive workpiece by analyzing the measured voltages, where a contact is determined to take place if a measured electrical voltage has a non-zero value.

When a cutting insert in the toolholder comes in contact with an electrically conductive workpiece material, the electric power source, the first connection unit, the cutting insert, the electrically conductive workpiece and the second connection unit forms a closed electrical circuit, which results in an electrical current flowing through the circuit. When the electrical current flows through the first connection unit, an electrical voltage is measurable over the first connection unit, according to Ohm's law: U=R·I, where U is the electrical voltage, R is the electrical resistance, and I is the electrical current.

However, if a cutting insert is not in contact with an electrically conductive workpiece, no closed circuit is formed and no electrical current flows through the circuit. Accordingly, no electrical voltage is measurable over the first connection unit.

Accordingly, if a measured electrical voltage over any of the first connection units has a non-zero value, this indicates that the corresponding cutting insert is in contact with the electrically conductive workpiece, and the cutting tool is thus in contact with the workpiece.

Since the electrical voltage over each of the first connection units is measured, and since the cutting inserts are electrically insulated from the toolholder, it is possible to determine a contact between individual inserts in the toolholder and an electrically conductive workpiece, which results in a very accurate determining of the position of different cutting edges in the cutting tool.

The electrical voltage over each first connection unit is preferably measured by measuring the electrical voltage over the resistor in the respective first connection unit.

According to an embodiment, the method further comprises the step of:
arranging the toolholder, the electrically conductive workpiece, and one of the first or second poles of the electric power source at the same electrical potential.

By having the toolholder, the electrically conductive workpiece material, and one of the first or second poles of the electric power source arranged at the same electrical potential, the measurement of the electrical voltages over the first connection units are facilitated, due to the reduced amount of calibration needed to be performed by the analysis unit.

According to an embodiment, the method further comprises the step of:
electrically grounding the toolholder, the electrically conductive workpiece, and one of the first or second poles of the electric power source.

By having the toolholder, the electrically conductive workpiece material, and one of the first or second poles of the electric power source electrically grounded, the measurement of the electrical voltages over the first connection units are facilitated, due to the reduced amount of calibration needed to be performed by the analysis unit.

According to an embodiment, the method further comprises the step of:
determining a contact between each of the n cutting inserts and the electrically conductive workpiece by analyzing the measured electrical voltages, where a contact is determined to take place if the measured electrical voltage has a non-zero value.

By determining a contact between each of the n cutting inserts and an electrically conductive workpiece based on the measured electrical voltages, a very accurate determining of the position of all different cutting edges in the cutting tool can be made and thereby reducing the risk of incorrect calibrations and thereby reducing the risk of low quality of the machined workpiece.

According to an embodiment, the method further comprises the steps of:
determining the measured electrical voltages as a function of time; and
determining a time of contact between any of the n cutting inserts and the electrically conductive workpiece.

According to an embodiment, the method further comprises the step of:
determining a time of contact between each of the n cutting inserts and the electrically conductive workpiece.

According to an embodiment, the method further comprises the steps of:
comparing the determined time of contact with a minimum threshold; and
discarding the determined contact if the determined time of contact is shorter than the minimum threshold value.

By discarding determined contacts where the time of contact is shorter than the minimum threshold value, the amount of false determination is reduced. There might be, for example, a situation where a flying chip from the cutting process will, for a very short time, come in contact with a non-cutting cutting insert and the electrically conductive workpiece, thereby closing the electric circuit between the non-cutting insert and the electrically workpiece material, which will then be determined as a contact. If the determined contact is discarded if the time of contact is shorter than a minimum threshold value this problem will be reduced. The minimum threshold value depends on the cutting process, e.g. which cutting feed rate or which rotational cutting speed is used.

According to one embodiment, the method further comprises the steps of:
determining a plurality of subsequent contacts between each of the n cutting inserts and the electrically conductive workpiece; and
determining the accumulated time of contact between each of the n cutting inserts and the electrically conductive workpiece.

By determining the accumulated time of contact between each of the n cutting inserts and an electrically conductive workpiece it is possible to estimate the amount of wear of each of the n cutting inserts since the wear is a function of the time of cut.

According to an embodiment, the method further comprises the steps of:
comparing the determined accumulated time of contact with a maximum threshold value;
generating a warning signal if the determined accumulated time of contact is equal to or higher than the maximum threshold value;
generating a warning based on the generated warning signal; and
presenting the warning via a user interface.

By comparing the accumulated time of contact with a maximum threshold value, it is possible for the analysis unit to determine when it is time to change the cutting insert since the wear of the cutting insert is a function of the time of cut. By doing this comparison it is possible to optimize the usage of each of the n cutting insert by not changing the cutting inserts too soon, which would result in an ineffective usage of the cutting inserts, and not too late, which would affect the quality of the machined workpiece. By presenting the warning via the user interface, an operator of the cutting tool is informed that it is time to change one or more of the n cutting inserts. The maximum threshold value depends on which cutting operation that is performed, which cutting data parameters that are used, e.g. cutting feed rate and rotational cutting speed, which type of workpiece that is processed, and which type of cutting inserts that are used in the cutting operation.

According to an embodiment, the method further comprises the step of:
storing the accumulated time of contact between each of the n cutting inserts and the electrically conductive workpiece in a database.

The stored accumulated time of contact is preferably cross-referenced with information regarding the cutting process, such as cutting data parameters, type of workpiece processed and cutting insert information, in the database.

By storing the determined accumulated time of contact in the database, it is possible to track the historical usage of each of the n cutting inserts mounted in the toolholder.

### BRIEF DESCRIPTION OF THE DRAWINGS

FIG. 1 schematically illustrates a system for determining contact between a cutting tool and an electrically conductive workpiece according to an embodiment of the invention,

FIG. 2 schematically illustrates the electrical circuit and the measurement unit comprised in the system illustrated in FIG. 1,

FIG. 3 schematically illustrates a flow chart of example method steps for determining contact between a cutting tool and an electrically conductive workpiece according to an embodiment of the invention.

### DETAILED DESCRIPTION

The disclosed embodiments will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that the disclosure will be thorough and complete, and will fully convey the scope of the invention to those skilled in the art. Like reference numbers refer to like elements throughout. The elements illustrated in the drawings are not necessary according to scale. Some elements might have been enlarged in order to clearly illustrate those elements.

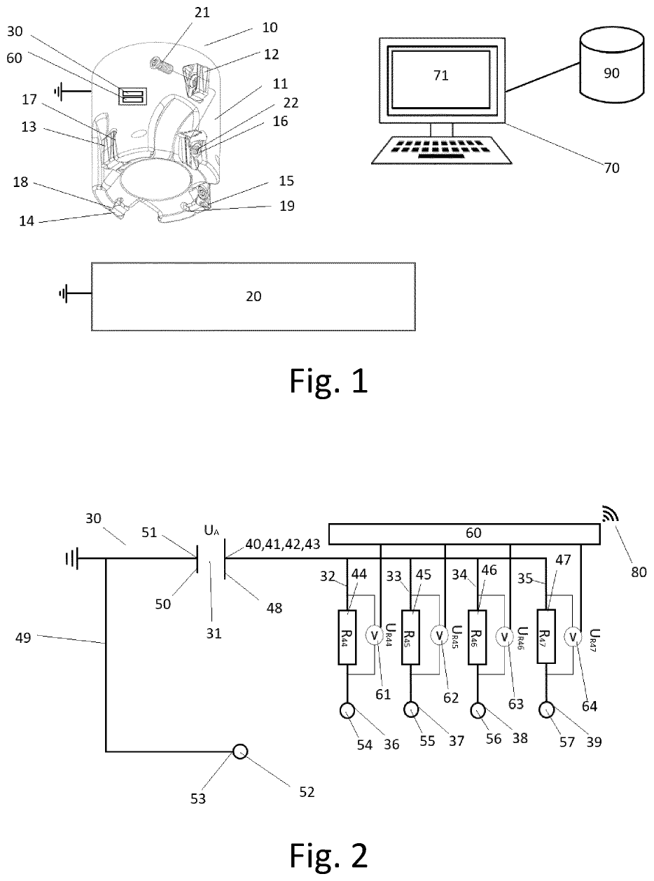

FIG. 1 schematically illustrates a system for determining contact between a cutting tool (10) and an electrically conductive workpiece (20) according to an embodiment of the invention. The system comprises a cutting tool (10) in form of a milling cutter. The cutting tool (10) comprises a toolholder (11) having four insert pockets (16, 17, 18, 19) in which four cutting inserts (12, 13, 14, 15) are mounted. The cutting tool (10) is configured to bring the cutting inserts (12, 13, 14, 15) in and out of contact with an electrically conductive workpiece (20). Each of the four insert pockets (16, 17, 18, 19) comprises an electrically insulating material layer between the toolholder (11) and the cutting insert (12, 13, 14, 15) mounted in the insert pocket (16, 17, 18, 19). The cutting inserts (12, 13, 14, 15) will thereby be electrically insulated from the toolholder (11). The cutting inserts (12, 13, 14, 15) are mounted in the toolholder (11) by use of fastening screws (21). Each insert pocket (16, 17, 18, 19) comprises a screw hole (22) for engagement with the fastening screw (21). The screw holes (22) comprise an electrically insulating material layer between the toolholder (11) and the fastening screw (21). The cutting inserts (12, 13, 14, 15) comprises an electrically conductive surface layer. The system further comprises an electrical circuit (30) and a measuring unit (60). The electrical circuit (30) and the measuring unit (60) are arranged in the toolholder (11). The measuring unit (60) is operatively connected to an analysis unit (70) in form of a computer. The analysis unit (70) comprises a user interface (71) in form of a display. The analysis unit (70) is operatively connected with a database (90). The toolholder (11) and the electrically conductive workpiece (20) are electrically grounded.

FIG. 2 schematically illustrates the electrical circuit (30) and the measuring unit (60) comprised in the system illustrated in FIG. 1. The electrical circuit (30) comprises an electric power source (31) in form of a battery, arranged to generate an electrical voltage (U_{A}). The electrical circuit (30) further comprises four first connection units (32, 33, 34, 35), which each comprises a first end (36, 37, 38, 39), and second end (40, 41, 42, 43), and, between the first end (36, 37, 38, 39) and the second end (40, 41, 42, 43), a resistor (44, 45, 46, 47) having an electrical resistance (R₄₄, R₄₅, R₄₆, R₄₇), wherein each of the four first connection units (32, 33, 34, 35) comprise an electrical contact pad (54, 55, 56, 57) at the first end (36, 37, 38, 39), which is configured to be arranged in electrical contact with the electrically conductive surface layer of one respective cutting insert (12, 13, 14, 15). Each of the four first connection units (32, 33, 34, 35) are connected to a first pole (48) of the electric power source (31) at the second end (40, 41, 42, 43), wherein each of the four first connection units (32, 33, 34, 35) are electrically connected to the first pole (48) in parallel with all the other three first connection units (32, 33, 34, 35). The electric circuit (30) further comprises a second connection unit (49) operatively connected to a second pole (50) of the electric power source (31) at a first end (51) and comprising a contact (52) configured to be electrically connected to an electrically conductive workpiece (20) at a second end (53). The second connection unit (49) is operatively connected to the second pole (50) of the electric power source (31) via an electrical cable. The measuring unit (60) comprises four measurement devices (61, 62, 63, 64) configured to measure an electrical voltage (U_{R44}, U_{R45}, U_{R46}, U_{R47}) over a respective resistor (44, 45, 46, 47). The resistors (44, 45, 46, 47) have a much higher electrical resistance (R₄₄, R₄₅, R₄₆, R₄₇) than the rest of the components in the first connection units (32, 33, 34, 35), approximately 1000 times higher, which makes the measured electrical voltage (U_{R44}, U_{R45}, U_{R46}, U_{R47}) over the resistor (44, 45, 46, 47) representative to the electrical voltage over the first connection unit (32, 33, 34, 35). The measuring unit (60) is operatively connected to the analysis unit (70) via a wireless connection (80). The second pole (50) of the electric power source (31) is electrically grounded.

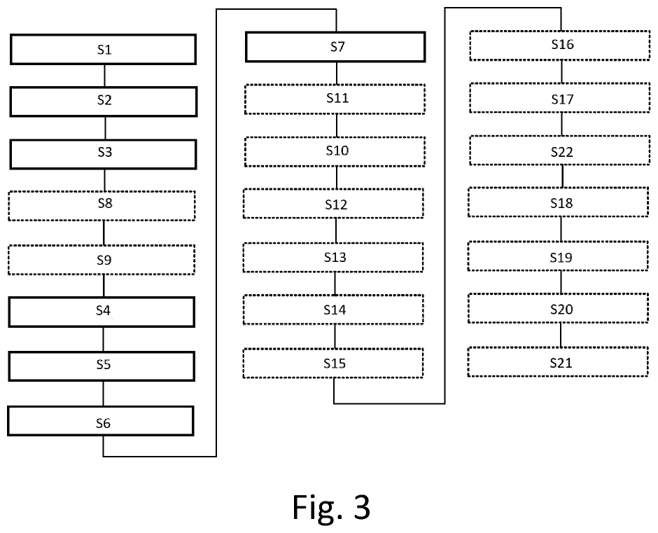

FIG. 3 schematically illustrates a flow chart of example method steps according to an embodiment of the invention. The method for determining contact between a cutting tool comprises the steps of:
S1: providing a system as described above;
S2: providing an electrically conductive workpiece (20);
S3: operatively connecting the electrically conductive workpiece (20) to the second pole (50) of the electric power source (31) via the contact (52);
S4: electrically charging the electrically conductive surface layer of the n cutting inserts (12, 13, 14, 15), by activating the electric power source;
S5: measuring an electrical voltage (U_{R44}, U_{R45}, U_{R46}, U_{R47}) over each first connection unit (32, 33, 34, 35);
S6: transmitting the measured electrical voltages (U_{R44}, U_{R45}, U_{R46}, U_{R47}) to the analysis unit (70); and
S7: determining a contact between the cutting tool (10) and the electrically conductive workpiece (20) by analyzing the measured electrical voltages (U_{R44}, U_{R45}, U_{R46}, U_{R47}), where a contact is determined to take place if a measured electrical voltage (U_{R44}, U_{R45}, U_{R46}, U_{R47}) has a non-zero value.

The method further comprises the step of:
S8: arranging the toolholder (11), the electrically conductive workpiece (20), and one of the first or second poles (48, 50) of the electric power source (31) at the same electrical potential.

The method further comprises the step of:
S9: electrically grounding the toolholder (11), the electrically conductive workpiece (20), and one of the first or second poles (48, 50) of the electric power source (31).

The method further comprises the step of:
S10: determining a contact between each of the n cutting inserts (12, 13, 14, 15) and the electrically conductive workpiece (20) by analyzing the measured electrical voltages (U_{R44}, U_{R45}, U_{R46}, U_{R47}), where a contact is determined to take place if the measured electrical voltage (U_{R44}, U_{R45}, U_{R46}, U_{R47}) has a non-zero value.

The method further comprises the steps of:
S11: determining the measured electrical voltages (U_{R44}, U_{R45}, U_{R46}, U_{R47}) as a function of time; and
S12: determining a time of contact between any of the n cutting inserts (12, 13, 14, 15) and the electrically conductive workpiece (20).

The method further comprises the step of:
S13: determining a time of contact between each of the n cutting inserts (12, 13, 14, 15) and the electrically conductive workpiece (20).

The method further comprises the steps of:
S14: comparing the determined time of contact with a minimum threshold value; and
S15: discarding the determined contact if the determined time of contact is shorter than the minimum threshold value.

The method further comprises the steps of:
S16: determining a plurality of subsequent contacts between each of the n cutting inserts (12, 13, 14, 15) and the electrically conductive workpiece (20); and
S17: determining the accumulated time of contact between each of the n cutting inserts (12, 13, 14, 15) and the electrically conductive workpiece (20).

The method further comprises the steps of:
S18: comparing the determined accumulated time of contact with a maximum threshold value;
S19: generating a warning signal if the determined accumulated time of contact is equal to or higher than the maximum threshold value;
S20: generating a warning based on the generated warning signal; and
S21: presenting the warning via a user interface (71).

The method further comprises the step of:
S22: storing the determined accumulated time of contact between each of the n cutting inserts (12, 13, 14, 15) and the electrically conductive workpiece (20) in a database (90).

1. A system for determining contact between a cutting tool and an electrically conductive workpiece, the system comprising:
a cutting tool including a toolholder and a plurality of cutting inserts mounted in the toolholder, wherein each of the plurality of cutting inserts includes an electrically conductive surface layer, wherein the cutting tool is configured to bring the plurality of cutting inserts in and out of contact with the electrically conductive workpiece, wherein each of the plurality of cutting inserts are electrically insulated from the toolholder;
an electrical circuit, wherein the electrical circuit comprises:
an electric power source arranged to generate an electrical voltage (U_{A}), and
a plurality of first connection units, each plurality of first connection units include a first end, a second end, and between the first end and the second end, a resistor having an electrical resistance, wherein each of the plurality of first connection units are electrically connected to a respective cutting insert at the first end and to a first pole of the electric power source at the second end, wherein each of the plurality of first connection units are electrically connected to the first pole in parallel with all the other first connection units, and
a second connection unit operatively connected to a second pole of the electric power source at a first end, the second connection unit including a contact configured to be electrically connected to the electrically conductive workpiece at a second end; and
a measuring unit and an analysis unit, wherein the measuring unit is configured to measure an electrical voltage over each of the first connection units, wherein the measuring unit is operatively connected to the analysis unit, and wherein the analysis unit is configured to determine a contact between the cutting tool and the electrically conductive workpiece based on the measured electrical voltages.

2. The system according to claim 1, wherein the electrically conductive workpiece is electrically connected to the second pole of the electric power source via the contact.

3. The system according to claim 2, wherein the toolholder, the electrically conductive workpiece, and one of the first or second poles of the electric power source have the same electrical potential.

4. The system according to claim 1, wherein the toolholder includes plurality of insert pockets, wherein each of the plurality of cutting inserts are mounted in one respective insert pocket, wherein each of the plurality of insert pockets includes an electrically insulating material layer between the toolholder and the cutting insert mounted in the insert pocket.

5. The system according to claim 1, wherein each of the plurality of first connection units includes an electrical contact pad at the first end, the electrical contact pad being arranged in electrical contact with the electrically conductive surface layer of a respective cutting insert of the plurality of cutting inserts.

6. The system according to claim 5, wherein each of the electric contact pads are arranged in one respective insert pocket between the electrically insulating material layer and the respective cutting insert mounted in the respective insert pocket.

7. The system according to claim 1, wherein all the plurality of first connection units have the same electrical resistance.

8. The system according to claim 1, wherein the analysis unit is configured to determine a contact between each of the plurality of cutting inserts and the electrically conductive workpiece based on the measured electrical voltages.

9. The system according to claim 1, further comprising a time measurement device is operatively connected to the analysis unit, and wherein the analysis unit is arranged to determine a time of contact between any of the plurality of cutting inserts and the electrically conductive workpiece.

10. The system according to claim 9, wherein the analysis unit is configured to determine the time of contact between each of the plurality of cutting inserts and the electrically conductive workpiece.

11. The system according to claim 9, wherein the analysis unit is configured to compare the determined time of contact with a minimum threshold value and to discard the determined contact if the determined time of contact is shorter than the minimum threshold value.

12. The system according to claim 10, wherein the analysis unit is configured to determine a plurality of subsequent contacts between each of the plurality of cutting inserts and an electrically conductive workpiece, and to determine an accumulated time of contact between each of the plurality of cutting inserts and the electrically conductive workpiece.

13. The system according to claim 12, further comprising a user interface operatively connected to the analysis unit, wherein the analysis unit is configured to compare the determined accumulated time of contact with a maximum threshold value, and wherein the analysis unit is configured to generate a warning signal if the determined accumulated time of contact is equal to or higher than the maximum threshold value, and wherein the system is configured to generate a warning based on the generated warning signal, wherein the warning is presented via the user interface.

14. The system according to claim 12, wherein the analysis unit is operatively connected to a database, and wherein the system is configured to store the determined accumulated time of contact between each of the plurality of cutting inserts and the electrically conductive workpiece in the database.

15. A method for determining contact between a cutting tool and an electrically conductive workpiece, the method comprises the steps of:
providing a system according to claim 1;
providing the electrically conductive workpiece;
operatively connecting the electrically conductive workpiece to the second pole of the electric power source via the contact;
electrically charging the electrically conductive surface layer of the n cutting inserts, by activating the electric power source;
measuring an electrical voltage over each first connection unit;
transmitting the measured electrical voltages to the analysis unit; and
determining a contact between the cutting tool and the electrically conductive workpiece by analyzing the measured electrical voltages, where a contact is determined to take place if the measured electrical voltage has a non-zero value.

16. The method according to claim 15, further comprising the step of arranging the toolholder, the electrically conductive workpiece, and one of the first or second poles of the electric power source at a same electrical potential.

17. The method according to claim 15, further comprising the step of determining a contact between each of the plurality of cutting inserts and the electrically conductive workpiece by analyzing the measured electrical voltages, wherein a contact is determined to take place if the measured electrical voltage has a non-zero value.

18. The method according to claim 15, further comprising the steps of:
determining the measured electrical voltages as a function of time; and
determining a time of contact between any of the plurality of cutting inserts and the electrically conductive workpiece.

19. The method according to claim 18, further comprising the step of determining a time of contact between each of the plurality of cutting inserts and the electrically conductive workpiece.

20. The method according to claim 18, further comprising the steps of:
comparing the determined time of contact with a minimum threshold value; and
discarding the determined contact if the determined time of contact is shorter than the minimum threshold value.

21. The method according to claim 19, further comprising the steps of:
determining a plurality of subsequent contacts between each of the plurality of cutting inserts and the electrically conductive workpiece; and
determining the accumulated time of contact between each of the plurality of cutting inserts and the electrically conductive workpiece.

22. The method according to claim 21, further comprising the steps of:
comparing the determined accumulated time of contact with a maximum threshold value;
generating a warning signal if the determined accumulated time of contact is equal to or higher than the maximum threshold value;
generating a warning based on the generated warning signal; and
presenting the warning via a user interface.

23. The method according to claim 21, further comprising the step of storing the determined accumulated time of contact between each of the plurality of cutting inserts and the electrically conductive workpiece in a database.
